(19) United States
(12) Patent Application Publication
(10) Pub. No.: US 2024/0348999 A1
(43) Pub. Date: Oct. 17, 2024

(54) Apparatus and Method for Multi Device Audio Object Rendering

(71) Applicant: Fraunhofer-Gesellschaft zur Förderung der angewandten Forschung e.V., München (DE)

(72) Inventors: Andreas WALTHER, Erlangen (DE); Sebastian MEYER, Erlangen (DE); Hanne STENZEL, Erlangen (DE); Julian KLAPP, Erlangen (DE); Marvin TRÜMPER, Erlangen (DE)

(21) Appl. No.: 18/749,959

(22) Filed: Jun. 21, 2024

Related U.S. Application Data
(63) Continuation of application No. PCT/EP2022/087672, filed on Dec. 23, 2022.

(30) Foreign Application Priority Data
Jan. 4, 2022 (WO) PCT/EP2022/050102

(51) Int. Cl. H04S 5/00; H04S 7/00

(52) U.S. Cl. CPC H04S 5/00; H04S 7/302

(57) ABSTRACT

An apparatus for generating one or more audio channels for a reproduction device from one or more audio object signals is provided. Each of the one or more audio object signals is associated with an audio object of one or more audio objects. The apparatus is configured to determine first rendering information depending on a position of the reproduction device and depending on a position of each audio object of the one or more audio objects. Moreover, the apparatus is configured to determine second rendering information depending on a capability of the reproduction device to replay spatial sound. Furthermore, the apparatus is configured to generate the one or more audio channels from the one or more audio object signals depending on the first rendering information and depending on the second rendering information.

### CROSS-REFERENCE TO RELATED APPLICATIONS

This application is a continuation of copending International Application No. PCT/EP2022/087672, filed Dec. 23, 2022, which is incorporated herein by reference in its entirety, and additionally claims priority from International Application No. EP PCT/EP2022/050102, filed Jan. 4, 2022, which is also incorporated herein by reference in its entirety.

The present invention relates to audio signal processing, to audio signal reproduction, to a reproduction of spatial audio and, in particular, to an apparatus and a method for multi device object rendering.

### BACKGROUND OF THE INVENTION

Audio coding techniques facilitate the convenient transmission of audio content in a diverse range of formats, such as stereophonic (two-channel) audio signals, multi-channel surround sound, immersive audio, interactive audio, object-based audio, and scene-based-audio. Thus, spatial audio content can not only be used in professional environments (like e.g. cinemas), but can also conveniently be transmitted into the consumer's home.

Enhanced reproduction setups for realistic sound reproduction often define loudspeaker positions around a listening area in the horizontal plane (usually at or close to ear-height of the listener), and also specify additionally loudspeaker positions distributed around the listening area in vertical directions. Those loudspeaker positions may either be elevated (mounted on the ceiling, or at some angle above head height) or may be placed below the listener's ear height (e.g. on the floor, or on some intermediate or specific angle).

Audio content is then mixed or rendered for the defined reproduction setup such that a single audio input signal is available for each loudspeaker at the defined position.

FIG. 2 illustrates different mono-devices and spatial-devices, such as exemplary loudspeakers and exemplary soundbars.

Inter alia, FIG. 2 illustrates an example of a loudspeaker 210 having a single driver. A loudspeaker can be passive (i.e. it receives its input signal from an external amplifier), or it can be an active loudspeaker which comprises an amplifier. Furthermore, it could be a two-way loudspeaker (see two-way loudspeaker 220 in FIG. 2) or a three-way loudspeaker with dedicated transducers for different frequency ranges, and may, e.g., include either passive or active crossover networks.

In the following, examples for playback-devices, for example, loudspeakers and/or, for example, soundbars, and examples of their capabilities are provided.

An important characteristic of a loudspeaker (as defined here: a loudspeaker is understood to mean loudspeaker for playing back a single-channel) is that it is a device that can e.g. only play back a single audio input signal and is designed for example such that it has a dedicated main axis at which it is mainly emitting sound to, or it is designed such that it radiates omnidirectionally. It does not include any dedicated device-specific spatial effects or virtualization. Sometimes, such devices will explicitly be denoted mono-loudspeaker or mono-device in the following.

A convenient alternative to complex setups of multiple individual mono-loudspeakers at different positions are compact reproduction systems that use signal processing means or hardware arrangements to recreate spatial reproduction from a single device. Such devices aim to emulate a sound impression for the listener that resembles the impression achieved by the dedicated multi-channel loudspeaker setup. In order to do so, these devices distribute signal energy into different directions and/or use psychoacoustic processing to generate some kind of spatial auditory perception.

Such compact reproduction devices and topologies may, for example, be soundbars, TVs with built in loudspeakers, boomboxes, Bluetooth loudspeakers, stereo loudspeakers, soundplates, loudspeaker arrays, smart speakers, and a large number of other kind of reproduction devices and reproduction topologies.

Some playback devices or compact reproduction systems (like Bluetooth loudspeakers or cheaper smart speakers) may, for example, comprise means for processing two or more signals, but their hardware just allows to play back a single signal (e.g. because they only have a single loudspeaker driver built in). If such a device receives e.g. a stereo or multi-channel signal, a usual playback strategy is to play back a mono-downmix of the two or more input signals, such that the device effectively becomes a mono-device.

In the following, a loudspeakers or a device that is capable of using either physical means or signal processing means to reproduce more than one audio input channel and to produce some kind of spatial audio effect or spatial perception will be denoted as a spatial-device or as a spatial-loudspeaker.

An example of a simple spatial-loudspeaker may e.g. be a stereo loudspeaker with two drivers in a single enclosure as depicted by stereo loudspeaker 230 in FIG. 2. If a device is capable of playing back a two-channel stereo input, a simple common device-rendering strategy may, e.g., be configured to reproduce one channel to be reproduced on the left side of the room and the other channel on the right side of the room. The two drivers then point to different directions with the left driver playing back the left channel signal of a two-channel input signal and with the right driver playing back the right channel signal of a two-channel input signal.

For multi-channel or object-based input, the left and right drivers could e.g. be used to play back downmixes of the input content that are intended for the left side or right side.

With the advent of multichannel and recently 3D audio and immersive audio, the number of compact playback devices capable of playing back more audio channels has also evolved. Many devices are available in the market that feature a significant number of loudspeaker drivers in a single enclosure for reproducing (but not limited to) spatial audio content with a high number of audio channels or object-based audio. Currently, examples exist on the market in soundbars and smart speakers that are capable of playing back immersive and 3D audio input signals.

The specifics of how such device-specific rendering of the input channels is handled in different devices is a design decision of the device manufacturers. It can be achieved e.g. by means of designing the hardware in a specific way, e.g., placing different loudspeaker drivers (for example, different loudspeaker drivers of a soundbar as depicted by soundbar 240 in FIG. 2), e.g. such that they point in different directions that correspond to the playback direction that is intended for the input audio channel. In embodiments, access to the individual drivers of the one or more reproduction devices is not necessarily needed.

Another example is to use means of signal processing devices (often referred to as virtualization, wherein the device is often referred to as a virtualizer) to create virtual audio channels (see, for example, soundbar 250 or smart speaker 260 in FIG. 2), for example, by steering beams of sound from a multi driver array into specific directions, or by using psychoacoustic effects through signal processing techniques such as cross talk cancelation, HRTF processing, or BRIR processing.

It would be highly appreciated, if improved concepts for respective audio signal processing would be provided.

### SUMMARY

An embodiment may have an apparatus for generating one or more audio channels for a reproduction device from one or more audio object signals, wherein each of the one or more audio object signals is associated with an audio object of one or more audio objects, wherein the apparatus is configured to determine first rendering information depending on a position of the reproduction device and depending on a position of each audio object of the one or more audio objects, wherein the apparatus is configured to determine second rendering information depending on a capability of the reproduction device to replay spatial sound, and wherein the apparatus is configured to generate the one or more audio channels from the one or more audio object signals depending on the first rendering information and depending on the second rendering information.

Another embodiment may have a reproduction device, wherein the reproduction device includes the inventive apparatus, wherein the inventive apparatus is configured to generate one or more audio channels for the reproduction device.

According to another embodiment, a system may have: the inventive reproduction device, being a first reproduction device, and one or more further reproduction devices.

According to another embodiment, a method for generating one or more audio channels for a reproduction device from one or more audio object signals, wherein each of the one or more audio object signals is associated with an audio object of one or more audio objects, may have the steps of: determining first rendering information depending on a position of the reproduction device and depending on a position of each audio object of the one or more audio objects, determining second rendering information depending on a capability of the reproduction device to replay spatial sound, and generating the one or more audio channels from the one or more audio object signals depending on the first rendering information and depending on the second rendering information.

Another embodiment may have a non-transitory digital storage medium having a computer program stored thereon to perform the inventive method when said computer program is run by a computer.

An apparatus for generating one or more audio channels for a reproduction device from one or more audio object signals is provided. Each of the one or more audio object signals is associated with an audio object of one or more audio objects. The apparatus is configured to determine first rendering information depending on a position of the reproduction device and depending on a position of each audio object of the one or more audio objects. Moreover, the apparatus is configured to determine second rendering information depending on a capability of the reproduction device to replay spatial sound. Furthermore, the apparatus is configured to generate the one or more audio channels from the one or more audio object signals depending on the first rendering information and depending on the second rendering information.

Moreover, a method for generating one or more audio channels for a reproduction device from one or more audio object signals is provided. Each of the one or more audio object signals is associated with an audio object of one or more audio objects. The method comprises:
Determining first rendering information depending on a position of the reproduction device and depending on a position of each audio object of the one or more audio objects.
Determining second rendering information depending on a capability of the reproduction device to replay spatial sound. And:
Generating the one or more audio channels from the one or more audio object signals depending on the first rendering information and depending on the second rendering information.

Furthermore, a computer program for implementing the above-described method, when being executed on a computer or signal processor is provided.

### BRIEF DESCRIPTION OF THE DRAWINGS

Embodiments of the present invention will be detailed subsequently referring to the appended drawings, in which:

FIG. 1 illustrates an apparatus for generating one or more audio channels for a reproduction device from one or more audio object signals according to an embodiment.

FIG. 2 illustrates different mono-devices and spatial-devices, such as exemplary loudspeaker assemblies, exemplary soundbars, and an exemplary smart speaker.

FIG. 3 illustrates a device specific configuration of component channels.

FIG. 4 illustrates an apparatus for rendering according to a particular embodiment and a general allocation of audio signals in such an embodiment.

FIG. 5 illustrates object panning conducted by a first renderer between a first device and a second device depending on the positions or directions of the object and of the first device and of the second device according to a particular embodiment.

FIG. 6 illustrates a relation between audio object position and a selection of component according to an embodiment.

FIG. 7A illustrates an example for device-specific panning curves for a device depending on an azimuth angle of an object according to an embodiment.

FIG. 7B illustrates an example for device-specific panning curves for a device depending on an azimuth angle of an object according to another embodiment.

FIG. 8 illustrates an adaptation of object position data to corresponding component channels depending on the device position according to an embodiment.

FIG. 9 illustrates an effect of a combination of both renderers for reproducing a specific audio object by employing suitable component channels according to an embodiment.

FIG. 10 illustrates another particular apparatus for rendering according to a further embodiment and a signal flow of the system according to an embodiment.

### DETAILED DESCRIPTION OF THE INVENTION

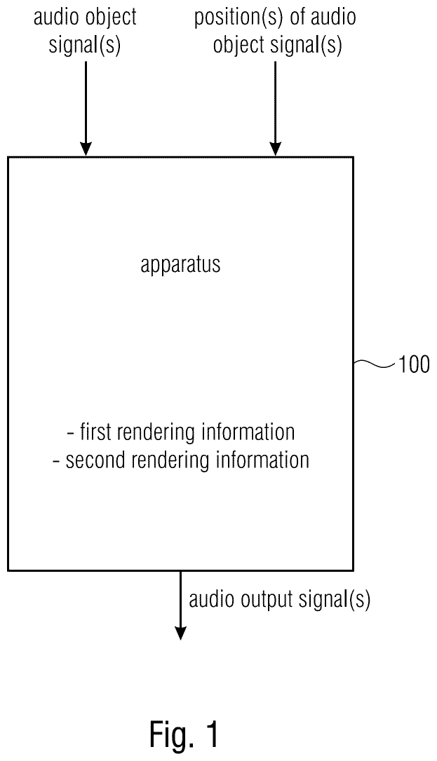

FIG. 1 illustrates an apparatus 100 for generating one or more audio channels for a reproduction device from one or more audio object signals according to an embodiment. Each of the one or more audio object signals is associated with an audio object of one or more audio objects.

The apparatus 100 is configured to determine first rendering information depending on a position of the reproduction device and depending on a position of each audio object of the one or more audio objects.

Moreover, the apparatus 100 is configured to determine second rendering information depending on a capability of the reproduction device to replay spatial sound.

Furthermore, the apparatus 100 is configured to generate the one or more audio channels from the one or more audio object signals depending on the first rendering information and depending on the second rendering information.

For example, the reproduction device may, e.g., output the one or more audio channels for the reproduction device using one or more loudspeaker drivers of the reproduction device.

Or, for example, the reproduction device may, e.g., process the one or more audio channels for the reproduction device to obtain one or more processed channels and may, for example, output the one or more processed channels for the reproduction device using the one or more loudspeaker drivers of the reproduction device. For example, the reproduction device may, e.g., process the one or more audio channels by, e.g., filtering, and/or by modifying and/or by combining the one or more audio channels to obtain the one or more processed channels.

According to an embodiment, the reproduction device may, e.g., comprise two or more loudspeaker drivers, wherein the capability of the reproduction device to replay spatial sound may, e.g., comprise a capability of the reproduction device to spatially replay the spatial sound. The apparatus 100 may, e.g., be configured to generate two or more audio channels for the two or more loudspeaker drivers of the reproduction device depending on the one or more audio object signals, depending on the first rendering information and depending on the second rendering information.

In an embodiment, the apparatus 100 may, e.g., be configured to determine the second rendering information depending on a spatial arrangement of the two or more loudspeaker drivers within the reproduction device.

According to an embodiment, the reproduction device may, e.g., comprise three or more loudspeaker drivers. The apparatus 100 may, e.g., be configured to generate three or more audio channels for the three or more loudspeaker drivers of the reproduction device depending on the one or more audio object signals, depending on the first rendering information and depending on the second rendering information. Moreover, the apparatus 100 may, e.g., be configured to determine the second rendering information depending on a spatial arrangement of the three or more loudspeaker drivers within the reproduction device.

In some embodiments, the reproduction device may, e.g., comprise four, five, seven, nine or any other number of loudspeaker drivers (e.g., that can be technically arranged in a reproduction device).

In an embodiment, the apparatus 100 may, e.g., be configured to determine the second rendering information depending on the position of each of the one or more audio objects depending on an orientation of the reproduction device in an environment.

According to an embodiment, the apparatus 100 may, e.g., be configured to generate the two or more audio channels by generating two or more component channels, wherein the two or more audio channels are the two or more component channels or are derived from the two or more component channels. Each of the two or more component channels is associated with one of the two or more components of the reproduction device, wherein each of the two or more components defines a different region around the reproduction device. The apparatus 100 may, e.g., be configured to determine the second rendering information depending on a position of each audio object of the one or more audio objects, and depending on the two or more components. Moreover, the apparatus 100 may, e.g., be configured to generate the two or more component channels using the second rendering information.

In an embodiment, each component channel of the two or more component channels may, e.g., comprise signal portions of those of the one or more audio object signals of the one or more audio objects which are located in the region around the reproduction device, which is defined by the component that comprises said component channel.

According to an embodiment, each component channel of the two or more component channels may, e.g., comprise more average signal energy of the signal portions of those of the one or more audio object signals of the one or more audio objects which are located in the region around the reproduction device, which is defined by the component that comprises said component channel, than any other component channel of the two or more component channels. A first component channel of the two or more component channels comprises more average signal energy of the signal portions of an audio object signal of the one or more audio object signals than a second component channel, if an average of the signal energy of the signal portions of the audio object signal in the first component signal is greater than an average of the signal energy of the signal portions of the audio object signal in the second component signal.

In an embodiment, each of the two or more components may, e.g., define an angular region around the reproduction device such that each of the two or more components is definable by an angle.

According to an embodiment, the apparatus 100 may, e.g., be configured to determine the second rendering information such that the second rendering information indicates a mapping rule for mapping (e.g., panning) the one or more audio object signals or one or more modified object signals derived from the one or more audio object signals to the two or more component channels depending on the two or more components associated with the two or more component channels and depending on the position of each audio object of the one or more audio objects which are associated with the one or more audio object signals.

In an embodiment, the two or more audio channels may, e.g., be the two or more component channels.

According to an embodiment, the apparatus 100 may, e.g., be configured to generate the two or more audio channels from the two or more component channels by processing at least one component channel of the two or more component channels, wherein the processing of the at least one component channel may, e.g., comprise one or more of:
amplifying or attenuating the at least one component channel in a time domain; and/or applying a gain and/or adding a delay to the at least one component channel in the time domain; and/or conducting a phase inversion on the at least one component channel in the time domain; and/or
applying a gain and/or adding a delay and/or conducting a phase inversion and/or a phase modification on one or more frequency bands of the at least one component channel in a frequency domain, and/or amplifying or attenuating at least one frequency band of the at least one component channel in a frequency domain; and/or
applying a filter operation on the at least one component channel; and/or
applying compression or limiting on the at least one component channel; and/or
applying equalisation on the at least one component channel.

In an embodiment, the apparatus 100 may, e.g., be configured to determine first rendering information depending on at least one distance being a distance between the position of the reproduction device and the position of an audio object of the one or more audio objects.

According to an embodiment, the at least one distance may, e.g., be an angular distance between the position of the reproduction device and the position of an audio object of the one or more audio objects.

According to an embodiment, the at least one distance may, e.g., be a linear distance between the position of the reproduction device and the position of an audio object of the one or more audio objects.

According to an embodiment, the apparatus 100 may, e.g., be configured to determine the first rendering information such that the first rending information indicates that a first audio object of the one or more audio objects having a greater distance from the reproduction device than a second audio object of the one or more audio objects shall be attenuated more than the second audio object.

In an embodiment, the apparatus 100 may, e.g., be configured to determine the first rendering information depending on the position of each of the one or more audio objects and depending on at least one further reproduction device of one or more further reproduction devices. Each further reproduction device of the one or more further reproduction devices is to reproduce one or more further audio signals for said further reproduction device, wherein said one or more further audio signals depend on the one or more audio object signals.

According to an embodiment, the apparatus 100 may, e.g., be configured to determine the first rendering information depending on a capability to replay spatial sound of said at least one further reproduction device and/or depending on a position of said at least one further reproduction device.

According to an embodiment, the apparatus 100 may, e.g., be configured to determine the first rendering information depending on the position of the reproduction device, depending on the position of each of the one or more audio objects and depending on a position of at least one of one or more further reproduction devices by employing amplitude panning.

In an embodiment, the apparatus 100 may, e.g., be configured to receive metadata comprising information on the position of each of the one or more further reproduction devices. The apparatus 100 may, e.g., be configured to determine the first rendering information and/or the second rendering information using the information on the position of each of the one or more further reproduction devices.

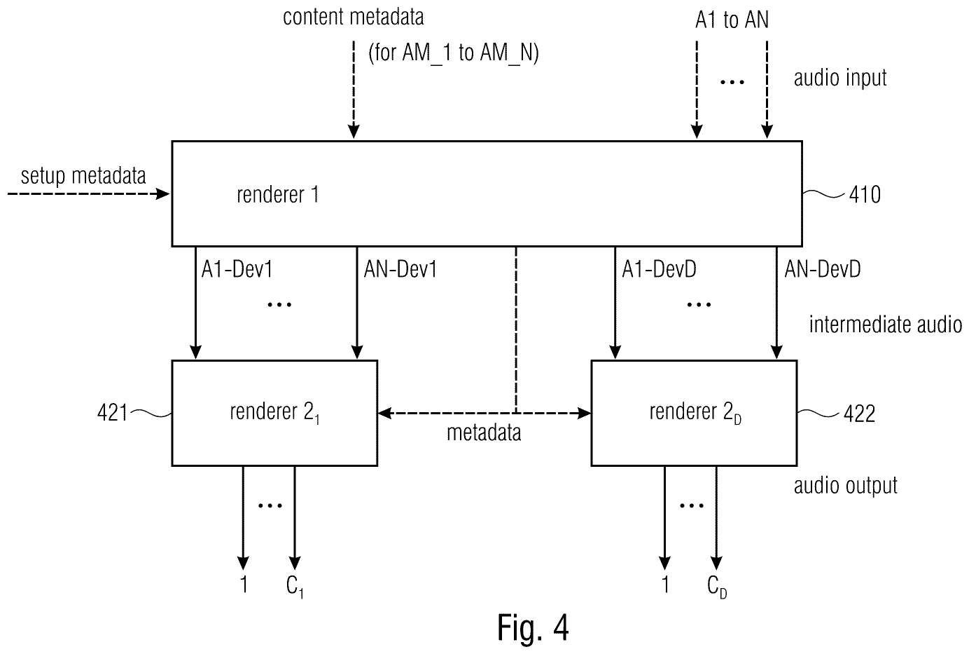

According to an embodiment, the apparatus 100, may, e.g., be configured to generate one or more modified object signals (e.g., the intermediate audio signals of FIG. 4) from the one or more audio object signals using the first rendering information which depends on the position of each of the one or more further reproduction devices. Moreover, the apparatus 100 may, e.g., be configured to generate the one or more audio channels from the one or more modified object signals using the second rendering information.

In an embodiment, the apparatus 100 may, e.g., be configured to receive information on that another reproduction device being different from the one or more further reproduction devices is to start reproducing at least one further signal which depends on the one or more audio object signals, and wherein, in response to said information, the apparatus 100 may, e.g., be configured to recalculate the first rendering information depending on said other reproduction device. Likewise the second rendering information may, e.g., be recalculated depending on said other reproduction device

And/or, the apparatus 100 may, e.g., be configured to receive information on that one of the one or more further reproduction devices is to stop or has stopped reproducing the further audio signal being reproduced by the further reproduction device, and wherein, in response to said information the apparatus 100 may, e.g., be configured to recalculate the first rendering information depending on said information. Likewise the second rendering information may, e.g., be recalculated depending on said information.

In an embodiment, the apparatus 100 may, e.g., be configured to determine the first rendering information and/or the second rendering information depending on a listening position.

According to an embodiment, the apparatus 100 may, e.g., be configured to generate the one or more audio channels for the reproduction device from two or more audio object signals, wherein each of the two or more audio object signals may, e.g., be associated with an audio object of two or more audio objects. Moreover, the apparatus 100 may, e.g., be configured to determine the first rendering information depending on a position of the reproduction device and depending on a position of each audio object of the two or more audio objects. Furthermore, the apparatus 100 may, e.g., be configured to generate the one or more audio channels from the two or more audio object signals depending on the first rendering information and depending on the second rendering information.

Moreover, a reproduction device is provided. The reproduction device comprises the apparatus 100 of FIG. 1. The apparatus 100 of FIG. 1 is configured to generate one or more audio channels for the reproduction device.

Furthermore, a system is provided. The system comprises a reproduction device, which comprises the apparatus 100 of FIG. 1, wherein the reproduction device is a first reproduction device, and one or more further reproduction devices.

According to an embodiment, the apparatus 100 of FIG. 1 of the first reproduction device is configured to determine the first rendering information depending on the position of the first reproduction device, depending on the position of each of the one or more audio objects and depending on a position of at least one of the one or more further reproduction devices.

In an embodiment, the apparatus 100 of FIG. 1 of the first reproduction device, may, e.g., be configured to generate the one or more audio channels for the first reproduction device.

For each further reproduction device of the one or more further reproduction devices, the apparatus 100 of FIG. 1 of the first reproduction device may, e.g., be configured to generate one or more audio channels for said further reproduction device, wherein, for generating the one or more audio channels for said further reproduction device, the apparatus 100 of FIG. 1 of the first reproduction device may, e.g., be configured
to determine first further rendering information for said further reproduction device depending on a position of the further reproduction device and depending on a position of each audio object of the one or more audio objects,
to determine second further rendering information for said further reproduction device depending on a capability of the further reproduction device to replay spatial sound, and
to generate the one or more audio channels for said further reproduction device from the one or more audio object signals depending on the first further rendering information for said further reproduction device and depending on the second further rendering information for said further reproduction device.

According to an embodiment each of the one or more further reproduction devices may, e.g., comprise an apparatus 100 of FIG. 1.

The apparatus 100 of FIG. 1 of each further reproduction device of the one or more further reproduction devices may, e.g., be configured to generate one or more audio channels for said further reproduction device, wherein, for generating the one or more audio channels for said further reproduction device, the apparatus 100 of FIG. 1 of said further reproduction device may, e.g., be configured
to determine first further rendering information for said further reproduction device depending on a position of the further reproduction device and depending on a position of each audio object of the one or more audio objects,
to determine second further rendering information for said further reproduction device depending on a capability of the further reproduction device to replay spatial sound, and
to generate the one or more audio channels for said further reproduction device from the one or more audio object signals depending on the first further rendering information for said further reproduction device and depending on the second further rendering information for said further reproduction device.

In the following, particular embodiments of the present invention are described.

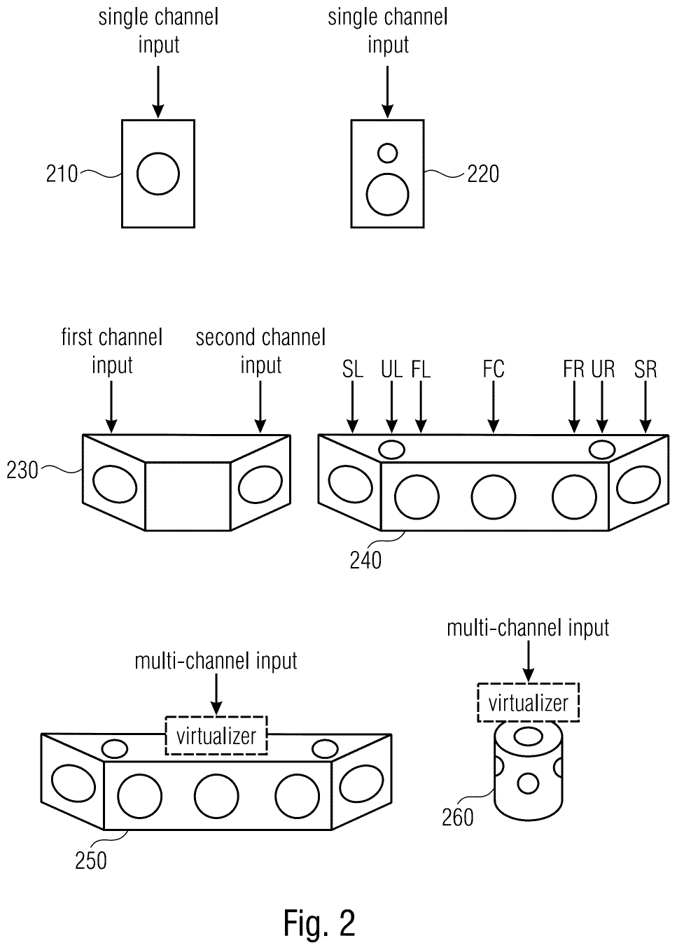

In FIG. 2, different loudspeaker setups have been shown. In embodiments, the examples of FIG. 2 can be further extended by loudspeakers featuring more input channels and by this offer more real or virtual output channels.

Embodiments relate to the technical fields of audio processing and audio reproduction. Specifically, some embodiments relate to the field of reproduction of spatial audio and describe an audio processor for rendering.

In specific embodiments, beneficial concepts for rendering are provided for scenarios, where the reproduction setup not only comprises single-channel loudspeakers or does not comprise single-channel loudspeakers, but where the reproduction setup comprises different types of playback-devices.

Some embodiments comprise different types of playback-devices, for example, typical single input loudspeakers and loudspeakers with built-in spatialization methods, for example, specific stereo-loudspeakers and/or, for example, smart speakers and/or soundbars, which, when used as a single, standalone device, may, e.g., already be capable of playing back spatial audio. In some embodiments, loudspeakers that are, alone, not capable of playing back spatial audio may, e.g., be integrated.

According to some embodiments, a system for reproducing audio signals in a sound reproduction system is provided, wherein the system comprises a variable number of loudspeaker assemblies or playback-devices, for example, of different kinds/types, at various positions.

Some embodiments are based on the finding that different types of loudspeaker assemblies and playback-devices exist in the market. In some embodiments, concepts are described how these different types of loudspeaker assemblies can be combined to make best possible use of their individual capabilities.

Embodiments provide concepts, which allow to automatically combine multiple smart speakers/smart device/spatial-devices and mono-devices (where each individual device may be of different size and different playback capabilities) into one reproduction system, and make use of the individual reproduction capabilities of each (spatial or mono) loudspeaker.

According to embodiments, the provided concepts may, e.g., also be employed in combination with mono-loudspeakers. However, it is specifically useful when used with devices that already offer functionality to generate some kind of spatial reproduction from a single device. Such functionality could be based on basic loudspeaker processing and signal routing or more complex signal processing, which is commonly referred to as “virtualization”, or in some device-classes as “beamforming”. Other terms may exist depending on the utilized technology or on brand-specific/manufacturer-specific nomenclature.

The multi device object rendering, provided by some embodiments, adapts rendering to the actually present playback scenario (e.g., to the present arrangement and combination of loudspeakers and playback-devices) and takes care that any content is reproduced in the best possible manner, e.g., as intended by the producer, or e.g., to generate an advantageous (e.g., most impressive) sound reproduction.

According to some embodiments, audio metadata and device metadata may, e.g., be provided (for example, as metadata to the apparatus 100 for rendering of FIG. 1) and may, e.g., be utilized (for example, by the apparatus 100 for rendering of FIG. 1) to define the audio distribution in the system. For example, the metadata may, e.g., comprise at least one of positions of the loudspeakers/devices (relative positions or absolute positions) and capabilities of the different loudspeakers/devices. In such embodiments, the rendering system may, e.g., create, depending on said metadata information, an advantageous interaction of all devices such that they can cooperatively generate an overall superior audio playback.

Usually, loudspeakers are positioned around a listening area, such that a faithful auditory perception can be created. The distribution of audio signals to different loudspeakers for producing the perception of auditory objects not only at the loudspeaker positions, but also at positions between the different loudspeakers, is usually called rendering or panning. Commonly used methods for rendering are, e.g., amplitude panning techniques.

In embodiments, concepts are provided that allow to distribute and render audio content to playback setups comprising one or more spatial-loudspeakers and/or spatial-devices and/or combinations of one or more spatial-devices with one or more mono-devices.

Some particular embodiments implement a two-step approach, which combines a general allocation of audio signals to a device/loudspeaker, followed by a device specific allocation of signals to available (real or virtual) output channels. It shall be noted that other embodiments realize the functionality of the two steps in a joint single step.

Considering a particular embodiment that implements a two-step approach, it should be noted that the order of the steps is not mandatory but may, e.g., be switched. Or, in another embodiment, both steps may be processed in parallel.

According to step 1 of the two-step approach, a general allocation of audio signals is conducted.

In step 1, a first audio renderer may, e.g., be used to distribute the audio signals to the available devices. The first renderer may, e.g., receive input audio signals with associated metadata and information about the reproduction setup (e.g. the information of positions of loudspeakers in the listening environment). Then, the first renderer may, e.g., be configured to distribute each audio signal individually to the devices depending on its associated metadata.

For the first renderer it is irrelevant, if the loudspeakers are spatial-devices or mono-devices and any known rendering method or panning method may, e.g., be employed. For example, in a particular embodiment, the first renderer may, e.g., be configured to generate for each audio object and for each reproduction device, a modified audio object (e.g., a weighted audio object) from said audio object for said reproduction device (e.g., using a panning concept), and may, e.g., be configured to feed said modified audio object into the second renderer, being a renderer for said reproduction device.

In contrast, according to the state of the art renderers the individual audio signals' contributions are summed and a single signal (a single loudspeaker feed) is sent to the individual loudspeakers/devices.

Conceptually, the first renderer assumes that all devices indicated at different positions are mono-loudspeakers. In embodiments, in order to enable the device specific allocation, however, the object based structure is maintained at the output of this renderer. E.g., all objects allocated to one specific device are not to be summed up to a single loudspeaker feed but are treated separately per object.

According to an embodiment, the allocation of audio signals to the available loudspeakers may, for example, be implemented as part of an audio signal chain, such that the first renderer outputs the resulting audio signals.

Or, in another embodiment, the allocation of audio signals to the available loudspeakers may, for example, be implemented using metadata such that the renderer outputs the gain weights that shall be applied per loudspeaker and audio signal individually. These weights can then be applied at any suitable place in the signal chain.

A key task of the first renderer is to distribute the weighted signal energy and/or the weighted audio signals to the available devices to position the audio sources in the generated sound field.

In step 2, a device specific rendering and/or allocation may, e.g., be conducted. The device specific allocation of signals is introduced since different device classes exist, each presenting a unique capability to reproduce sound spatially. When addressed individually, these unique capabilities can be utilized to produce an overall enhanced playback and make best possible use of the device at its current position.

In the following description, the variety in spatialization capabilities may, e.g., be referred to as available component channel or as available component.

Within the device specific signal allocation, the capabilities of different devices may, e.g., be known to the system. Thus, in this rendering step, audio signals are distributed separately/individually for each device such that the most suitable component channel or gain weighted component combination is chosen for each audio signal.

This rendering is performed separately for each available device, for example, relating the audio metadata with the device position information, and the reproduction capabilities of the device/the available component channels.

If the device is a mono-loudspeaker, then there may, e.g., be only one component, so the allocation strategy may, e.g., be to sum the device-signals to a mono-signal/single signal.

Embodiments of the present invention make an advantageous possible use of multiple loudspeakers of different kinds. In embodiments, even multiple spatial-devices that are capable of performing individual spatial device-rendering may, e.g., be beneficially combined to achieve an overall superior auditory impression.

To achieve this, some particular embodiments may, e.g., utilize the described two-stage rendering process. Other embodiments may, e.g., implement the above-described two-stage rendering process in a single stage, e.g., in each of a plurality of employed devices.

In an embodiment, each of the devices may, e.g., comprise a single rendering stage which comprises the full functionality of the system.

According to an embodiment, by using metadata information, a weighting of each of the audio object signals may, e.g., be conducted depending on position information or direction information of the audio objects which are associated with the audio object signals and depending on position information or direction information with respect to the location of the device. Moreover the weighted audio objects may be used to generate loudspeaker signals for the one or more loudspeakers of the device.

In another embodiment, the two steps may be conducted in the device by two renderers.

Or, in a further embodiment, a single renderer per device is employed, and the weighting and the generating of the loudspeaker signals from the audio object signals may, e.g., be conducted in a single, combined step.

As with standard mono-loudspeaker speaker setups, it is assumed that any loudspeaker (mono or spatial) may, e.g., be positioned at any place around a listening area.

The first renderer or of a first rendering stage may, e.g., be employed to distribute signal energy such that objects may, e.g., be best possibly rendered by using loudspeakers at the given loudspeaker positions. E.g., the first renderer/the first rendering stage may, e.g., be implemented to assume standard mono-loudspeakers. For example, the first renderer/the first rendering stage is configured to conduct rendering irrespective of the actual loudspeaker properties (for example, irrespective of the number of drivers the loudspeaker has).

Thus, according to embodiments, the first renderer may, e.g., distribute each audio object/audio object signal with weights for each device depending on the device's position (and, for example, depending on the position or direction of the audio objects).

The second renderer/the second rendering stage may, e.g., be configured to distribute and/or to render each audio object to selected component outputs of the spatial device. For example, the device may, e.g., comprise more than one loudspeaker driver and the second renderer/the second rendering stage may, e.g., render the audio object signals and generate two or more loudspeaker signals/two or more loudspeaker driver signals for the two or more loudspeaker drivers of the device.

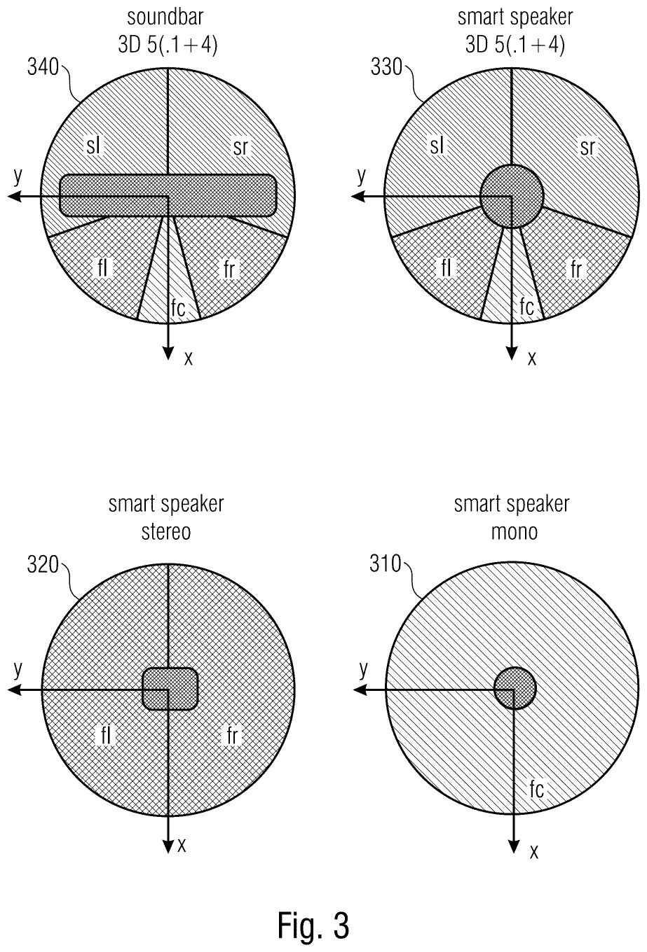

FIG. 3 illustrates a device specific configuration of component channels. In particular, FIG. 3 depicts plots of example devices 310, 320, 330, 340 and their available component channels.

Smart speaker mono 310 of FIG. 3 is an example of a mono-device. For simplicity, the single component it is able to reproduce is denoted as front center (fc), but any other channel name may, e.g., also be used. Even if the input to such a mono-device would be a multi-channel audio signal, e.g., a five-channel surround audio input signal, for example, a mono downmix of these five channels would be played back by the single component fc.

In FIG. 3, smart speaker stereo 320 is an example of a spatial device that can already render distinct signals for a left side and a right side. The two components/component channels may, e.g., be referred to as front left (fl) and front right (fr).

Moreover, in FIG. 3, smart speaker 3D 330 and Soundbar 3D 340 show different device classes that are both capable of reproducing, in the examples shown FIG. 3, five different spatial components, exemplified as front center (fc), front left (fl), front right (fr), surround left (sl), and surround right (sr). Such devices 330, 340 may comprise any other number of, e.g., at least three spatial components, for example, 3 or 4 or 6 or 7 or 9 or 11 or any other integer number of spatial components.

It is moreover understood that FIG. 3 depicts the four examples 310, 320, 330, 340 in a non-limiting way. In other embodiments, other configurations of components channels may, e.g., exist.

It is to be noted that while FIG. 3 only depicts two-dimensional examples, according to other embodiments, the same systematic of course also applies to the vertical dimension, and thus also applies to three dimensions. Each of the devices could also feature distinct height components in/for the vertical plane. To exemplify this on the basis of the smart speaker stereo shown above, according to other embodiments, a device may, for example, offer the components horizontal_front_left, horizontal_front_right, height_front_left, height_front_right, and a graphical representation of such a configuration would divide the sphere around the device into according segments. According to yet other embodiments, analogous to elevated height, devices may, e.g., also have components for reproduction of floor level sound.

For simplicity, all following examples are explained for two dimensional cases in the horizontal plane (2D), while the provided embodiments may, e.g., in other embodiments, equally be used for the vertical plane and/or a three dimensional (3D) domain, or combination of both.

It should be noted that the concept of component channels or component configuration or components shall not be taken to mean that a loudspeaker is able to reproduce an audio object signal exactly towards a specific direction. Instead, component channels/component configuration/components may, e.g., be understood as a model to visualize the concept of a selection of optimal component channel(s) depending on the position of an audio object in relation to the position of the device and the listener.

In short, in some embodiments, two steps may, e.g., be involved in those embodiments, namely, a first step, wherein audio objects may, e.g., be rendered to devices and a second step, where audio objects may, e.g., be rendered to device specific component channels.

In other embodiments, instead of conducting two steps, a single step may, e.g., be conducted that implements the functionality of both steps. For example, a renderer may, e.g., be placed in each of the devices and may, e.g., conduct the weighting of the audio object signals depending on the positions/directions of the device and of the audio object signals, and the generation of the loudspeaker driver signals in a single, combined step, e.g., by using a two-dimensional matrix that maps the objects to the loudspeaker driver channels, wherein the two-dimensional matrix may, e.g., comprise variable weights depending on the positions/directions of the objects.

In further embodiments, the order of the two steps may, e.g., be exchanged and the second step may, e.g., be conducted before the first step. For example, at first loudspeaker driver signals may, e.g., be created from the one or more audio object signals and afterwards, a weighting of the loudspeaker driver signals may, e.g., be conducted depending on the positions or directions of the one or more audio objects and depending on the position or direction of the device.

FIG. 4 illustrates an apparatus 100 for rendering according to a particular embodiment and a general allocation of audio signals in such an embodiment. In particular, FIG. 4 illustrates a first renderer 410, e.g., as described above, and two second renderers 421, 422, e.g., as described above.

In FIG. 4, the first renderer is configured to receive N audio signals as input, e.g., audio input signals A1 to AN.

Based on the information, where each of the 1 to N audio signals should be panned to and where each of the 1 to D loudspeakers/playback devices are positioned in the available reproduction setup, the input audio signals are weighted for/to the available devices (e.g., to generate intermediate audio signals/modified audio signals).

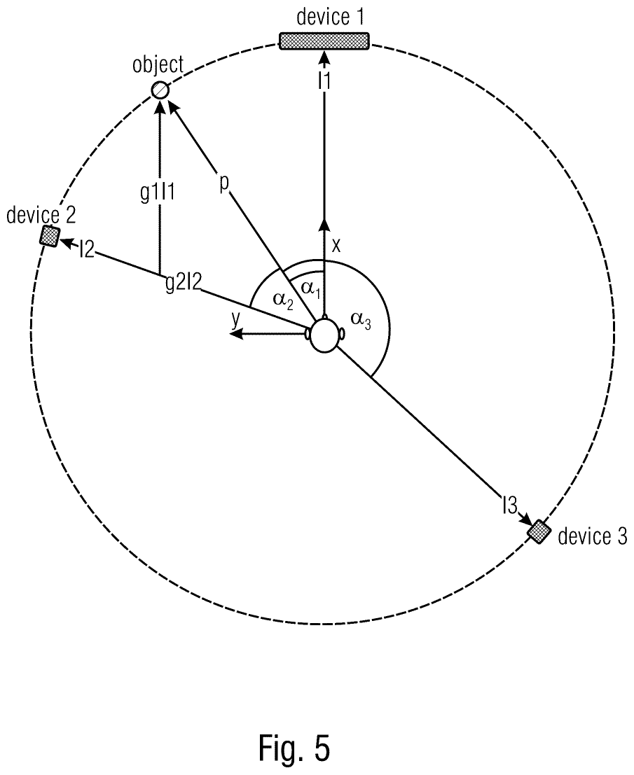

FIG. 5 illustrates object panning conducted by a first renderer 410 between a first device and a second device depending on the positions or directions of the object and of the first device and of the second device according to a particular embodiment. g1l1 indicates a size of a possible weight of the audio object signal of the object for device 1. g2l2 indicates a size of a possible weight of the audio object signal of the object for device 2.

As can be seen, rendering by the first renderer/determining the first rendering information may, e.g., be conducted depending on a listener position/listening position.

In the following, step 2 of the two-step approach, namely, device specific rendering, e.g., by the second renderers 421, 422 of FIG. 4, and/or allocation of signals is described.

As exemplified in FIG. 3, each available device has its own individual configuration of component channels, which may, for example, be defined as different angular regions, representing the component to be used for the reproduction of an audio object at a specific direction relative to the device itself.

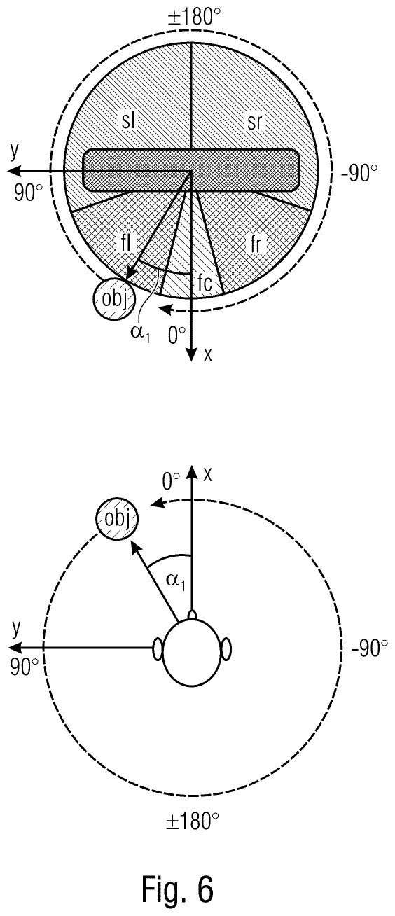

The angle or direction, pointing to the region where the loudspeaker shall reproduce an audio object may, e.g., be referred to as the device reproduction angle, (and depending on that, the selection of the component) depends on the spatial position of the object as defined in the object metadata. In the case of a single device position straight ahead of a listener, the device reproduction angle is equivalent to the object position. FIG. 6 illustrates this based on object metadata that defines the object position in a listener centric coordinate system.

It shall be noted that a device reproduction angle does not have to be the direction towards which the sound waves comprising the respective audio content are really emitted. Instead, it is only an angle that helps to choose the most suitable component for reproduction In FIG. 3 and FIG. 6, the component sl is located between 75° and 180°. Nonetheless, for example, a soundbar will usually not or not only emit the respective sound towards the between −75°- and −180° region. Instead, for example, a signal is, for example, generated, such that it is perceived as coming from a specific direction usually associated with a surround sound, or it may be generated such that it is perceived as being more diffuse than the front components. The actual device specific behavior is dependent on the hardware and/or driver arrangement and/or the capabilities and specifics of the used virtualizer or virtualization technique.

FIG. 6 illustrates a relation between audio object position and a selection of component according to an embodiment. FIG. 6 illustrates how an object pannend around a listener would be mapped to the components. The underlying calculations are based on standard vector algebra.

While explanations are provided here with respect to a listener centric coordinate system with listener centric metadata, in other embodiments, other coordinate systems and metadata may, e.g., be used, for example, room centric coordinate systems and metadata.

In the example of FIG. 6, an audio object is panned around a listener. Azimuth angle α₁ could also be interpreted as if it would be panned around the loudspeaker with the same angle. Determining the second rendering information may, e.g., be conducted depending on a listener position/listening position.

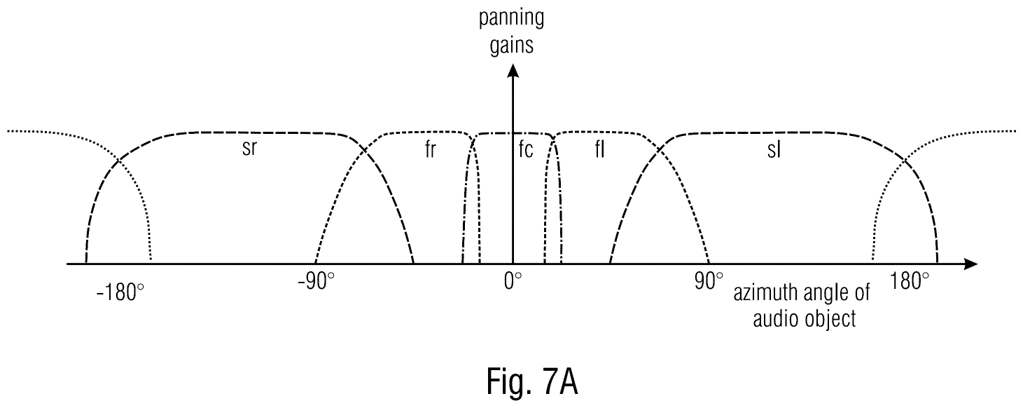

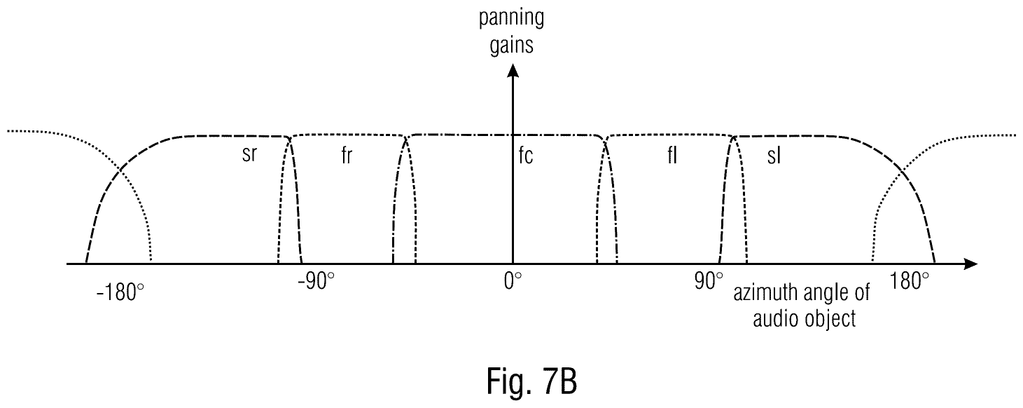

In embodiments, panning rules, for each loudspeaker and its specific configuration of component channels, may, e.g., be defined to ensure an advantageous combination (or even best combination) of the available components. An example of such device specific panning rules is depicted in FIG. 7A.

In particular, FIG. 7A illustrates an example for device-specific panning curves for a device depending on an azimuth angle of an object according to an embodiment.

FIG. 7B illustrates an example for device-specific panning curves for a device depending on an azimuth angle of an object according to another embodiment.

It can be seen, that in FIG. 7B, the front center (fc) component covers a broader (angular) region than in the example of FIG. 7A. Moreover, the panning gains (especially in the transition regions between different components) are also slightly changed in the other regions.

Even though FIG. 7A and FIG. 7B only show examples for panning between horizontal components based on an azimuth angle, similar functions can be defined for panning between vertical components, and/or for panning between horizontal and vertical components, and/or for panning depending on e.g. elevation angles, and/or for panning depending on azimuth and elevation angles.

Accordingly, in an embodiment, the apparatus 100 may, e.g., be configured to determine the two or more components differently depending on a property of an audio object signal of the one or more audio object signals, such that, if said audio object signal exhibits a first property, a region of at least one of the two or more components is different compared to if said audio object signal exhibits a different second property.

According to an embodiment, the first property of the audio object signal may, e.g., be that the audio object signal is a direct signal, and the second property of the audio object signal may, e.g., be that the audio object signal is an ambience signal.

In an embodiment, the first property of the audio object signal may, e.g., be that the audio object signal is a speech signal, and the second property of the audio object signal may, e.g., be that the audio object signal is a non-speech signal

In an embodiment, the locations of the regions defined by the components may, e.g., be adaptable. In a further embodiment, panning gains may, e.g., also be configurable.

In a particular embodiment, differently defined components may, e.g., be chosen for speech signals in contrast to non-speech signals (e.g., background signals, noise signals, ambience signals). For example, when five components are considered, e.g., front center, front left, front right, left surround, right surround, the angular ranges of front center, front left, front right components may, e.g., be increased and the angular ranges of left surround and right surround components may, e.g., be decreased for speech signals compared to non-speech signals.

In an embodiment, the first property of the audio object signal may, e.g., be that the audio object signal is a direct sound signal, and the second property of the audio object signal may, e.g., be that the audio object signal is an ambience sound signal.

In a particular embodiment, differently defined components may, e.g., be chosen for direct sound signals in contrast to ambient sound signals (e.g., reverberation, room sound, ambience signals). For example, when five components are considered, e.g., front center, front left, front right, left surround, right surround, the angular ranges of front center, front left, front right components may, e.g., be decreased and the angular ranges of left surround and right surround components may, e.g., be increased for ambience signals compared to direct signals.

Furthermore, the transition regions between different components may, e.g., be defined differently to allow more crosstalk/overlap between components (wider transition regions) or less crosstalk/overlap between components, depending on the signal property.

With such panning curves, the device specific rendering can be influenced. According to an embodiment, a transition between the different components may, e.g., be tuned/may, for example, be configurable.

In an embodiment, when using a device at positions other than straight ahead of the listener and/or when several devices at arbitrary positions are combined, the device reproduction angle may, for example, be defined as

Device reproduction angle=Object position metadata−device position metadata.

assuming listener centric azimuth and elevation.

Here, position metadata may, for example, denote metadata that defines a direction.

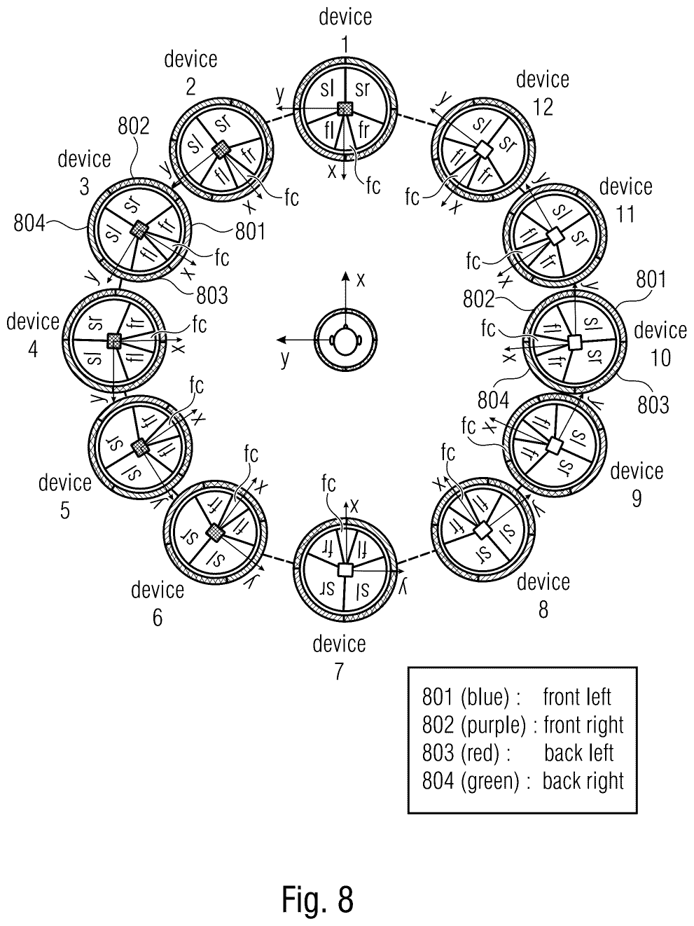

FIG. 8 illustrates an adaptation of object position data, indicated by the four angular regions front left 801, front right 802, back left 803, and back right 804, to the corresponding component channels depending on the device position according to an embodiment.

As can be seen, in the embodiment illustrated by FIG. 8, it may, for example (but not necessarily) be assumed that the fc component may, e.g., be directed to the listener position. This may, e.g., be achieved by setting up the device accordingly, or, e.g., by adjusting the playout direction of the device via signal processing, if the hardware allows for such an approach.

It should be noted that a component processing/allocation according to such an embodiment may, e.g., be independent of any specific virtualization or rendering technique used by the spatial device. Thus, it is not necessarily important to know which specific technique or virtualization is used by the spatial device to actually generate or process the components. The virtualization may, e.g., be considered as a black box, as long as a dedicated input for all component channels can be provided to the device, or, e.g., to the second renderer (in FIG. 4, e.g., to the second renderers 421, 422).

Nonetheless, as provided by particular embodiments, an overall quality can potentially further be improved, if device-specific virtualization and component panning can be aligned/harmonized and fine-tuned, as may be the case if the complete system design is designed and/or is done and/or is controlled by a single manufacturer. In an embodiment, the hardware design and the implementation of the virtualization may, e.g., done in combination with the implementation and tuning of the multiple device rendering system.

In the following, an arrangement of multiple loudspeakers and their component mixing depending on object panning according to embodiments is described.

Returning to FIG. 4, after the first renderer 410 has weighted the audio signals for every spatial-device, each of the second renderers 421, 422 decides to which component or mixture of components the object/the audio object signal shall be mixed. In an embodiment, this may, e.g., be realized depending on a relative opening angle between a 0° axis of the individual loudspeaker and an original panning angle with its original looking direction of the listener. E.g., object panning may, e.g., be conducted for each device, as if the listener's looking direction would rotate towards the main axis of the loudspeaker, and the position of an object may, e.g., not be changed, when such a change of the looking direction is conducted.

For every device that is involved in the reproduction of a specific audio object, the second renderer (e.g., each of the second renderers 421, 422 of FIG. 4) may, e.g., be configured to render the object to a suitable component or mix of/panning between different components using a suitable component channel.

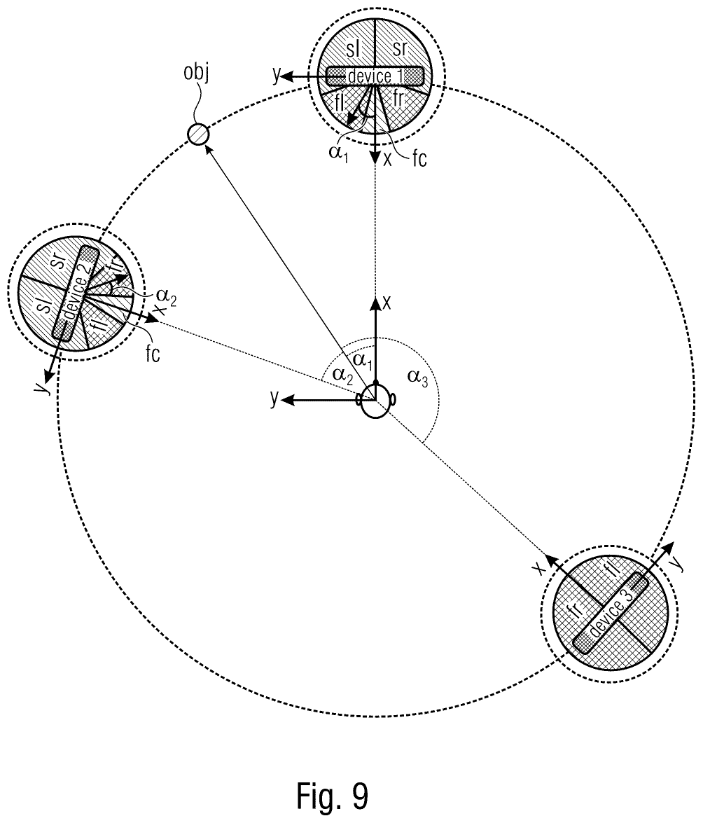

FIG. 9 illustrates an effect of a combination of both renderers for reproducing a specific audio object by employing suitable component channels according to an embodiment. The visualization in FIG. 9 depicts on which component channel an audio object, panned around a listener would be reproduced, if loudspeakers would be placed at different positions relative to the listener. Determining the first rendering information and/or the second rendering information may thus, e.g., be conducted depending on a listener position/listening position.

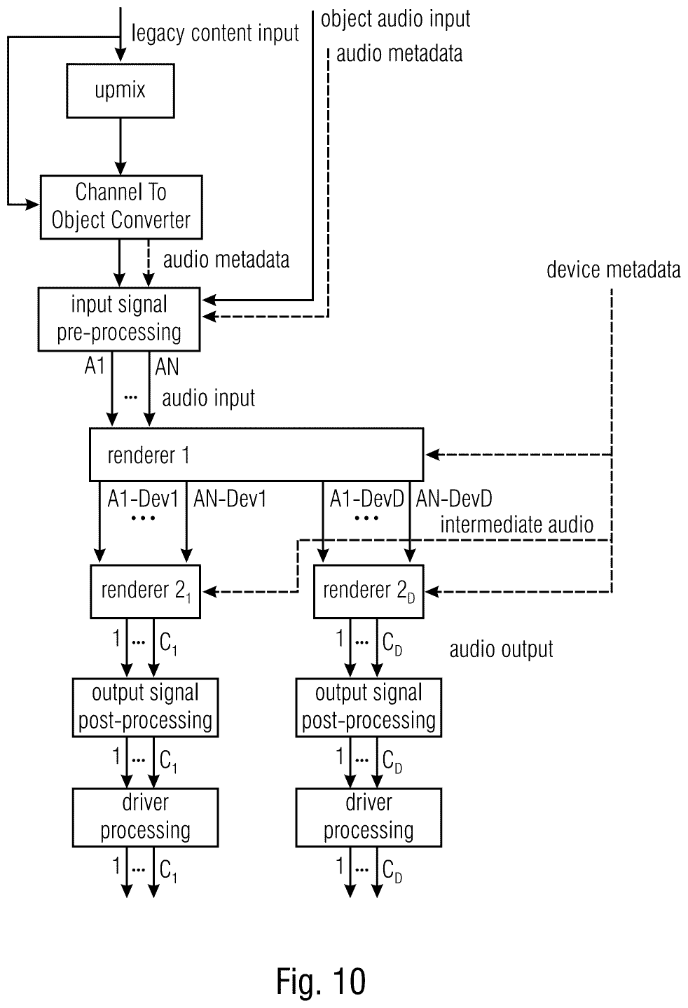

FIG. 10 illustrates another particular apparatus 100 for rendering according to a further embodiment and a signal flow of the system according to an embodiment. In particular, FIG. 10 illustrates an example of a complete system integration including potential pre-processing and post-processing steps.

According to an embodiment, legacy audio input may, e.g., be converted into object audio, e.g., into one or more audio objects. In FIG. 10, this is depicted in the “Channel To Object Converter” module.

In an embodiment, the Channel To Object Converter module may, e.g., be configured to generate audio metadata. For example, this may, e.g., be conducted depending on information about standard loudspeaker setups or ideal loudspeaker positions of the loudspeaker setups used during production, or e.g. depending on user input.

In the embodiment of FIG. 10, the Channel To Object Converter may, for example, be configured to convert each signal intended for a particular loudspeaker of a loudspeaker setup into an audio object. The audio waveform data may, e.g., get associated metadata that may, e.g., indicate the position, where the sound should be reproduced (which may, e.g., correspond to the loudspeaker position this channel was intended for). In an embodiment, the device metadata of FIG. 10 may, e.g., be the setup metadata of FIG. 4.

In some embodiments, in FIG. 10, the post-processing and/or driver processing of the audio output signals of the second renderers 2₁, . . . , 2_{D} may, e.g., comprise one or more of:
amplifying or attenuating one or more of the audio output signals in a time domain; and/or applying a gain and/or adding a delay to one or more of the audio output signals in the time domain; and/or conducting a phase inversion on one or more of the audio output signals in the time domain; and/or
applying a gain and/or adding a delay and/or conducting phase inversion on one or more frequency bands of one or more of the audio output signals in a frequency domain, and/or amplifying or attenuating at least one frequency band of one or more of the audio output signals in a frequency domain; and/or
applying a filter operation on one or more of the audio output signals; and/or applying compression or limiting on the audio output signal; and/or
applying equalisation on the audio output signal.

In a further embodiment, the pre-processing module may, e.g., be a speech extraction module, and the metadata may, e.g., indicate whether the audio object signal is a speech signal or is a non-speech signal (for example, the metadata may, e.g., indicate that the audio object signal is a background signal and/or a noise signal and/or an ambience signal).

In a further embodiment, the pre-processing module may, e.g., be a direct ambience decomposition module, and the metadata may, e.g., indicate whether the audio object signal is a direct sound signal or is an ambience sound signal (for example, the metadata may, e.g., indicate that the audio object signal is a reverberation, room sound, ambient signals).

Besides the position information, the metadata generated in the Channel To Object Converter may, e.g., also comprise additional information that may, e.g., indicate e.g. if the audio signal is the output of an optional upmix procedure, and, if this is the case, that may, e.g., indicate, if e.g. the signal is a direct sound or an ambience sound.

Position information in the metadata may, e.g. be explicit/absolute, and may, e.g., provide coordinates in a fixed coordinate system, or may, e.g., be implicit/relative (e.g. to a listening position), e.g., as angles (azimuth, elevation) and distance. Absolute positions may, e.g., be expressed with respect to some room coordinates.

According to embodiments, reproduction of legacy content (e.g. 2 two-channel stereo. 5.1, 7.1 surround) may, e.g., be possible. In embodiments, spatially enhanced sound may, e.g., be generated via an upmix.

According to embodiments, the input audio may, e.g., include content comprising channels, objects, or scene based audio.

In embodiments, different coordinate systems may, e.g., be employed, for example, Cartesian or spherical or listener centric or room centric coordinate systems.

According to embodiments, the complete system may, e.g., work in a master/slave fashion, where all rendering calculations may, e.g., be performed by a central master-device, which then distributes the loudspeaker feeds to the attached devices.

In embodiments, the system may, e.g., be implemented by a uniform/unified approach, where each device has the complete functionality included, so that every device can work autonomously, or in combination with any other device(s).

According to an embodiment, bass-management may, for example, be included.

In an embodiment, since also mono-devices may, e.g., be integrated into the system, even a small device, e.g., a mono device, or, e.g., any IoT (Internet of Things) device with one or more loudspeakers (e.g. light-bulbs, fridges, etc. . . . ) may, e.g., be integrated.

According to an embodiment, loudspeaker positions may, e.g., be detected by user input, or by any known signal processing means, for example, by acoustical, or optical, or by any other technical means.

In some embodiments, device metadata may, e.g., comprise one or more of:
device positions (azimuth, elevation, distance)
potentially also device orientation of one or more of the devices
device specifications, for example, available components/component channels (potentially angular ranges that could be considered for each component; and/or potentially an indication about the specific type of virtualization that is used; and/or a reproduction quality (e.g. fullband, narrowband, subwoofer, etc. . . . ).

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus for generating one or more audio channels for a reproduction device from one or more audio object signals, wherein each of the one or more audio object signals is associated with an audio object of one or more audio objects,
wherein the apparatus is configured to determine first rendering information depending on a position of the reproduction device and depending on a position of each audio object of the one or more audio objects,
wherein the apparatus is configured to determine second rendering information depending on a capability of the reproduction device to replay spatial sound, and
wherein the apparatus is configured to generate the one or more audio channels from the one or more audio object signals depending on the first rendering information and depending on the second rendering information.

2. An apparatus according to claim 1,
wherein the reproduction device comprises two or more loudspeaker drivers, wherein the capability of the reproduction device to replay spatial sound comprises a capability of the reproduction device to spatially replay the spatial sound, and
wherein the apparatus is configured to generate two or more audio channels for the two or more loudspeaker drivers of the reproduction device depending on the one or more audio object signals, depending on the first rendering information and depending on the second rendering information.

3. An apparatus according to claim 2,
wherein the apparatus is configured to determine the second rendering information depending on a spatial arrangement of the two or more loudspeaker drivers within the reproduction device.

4. An apparatus according to claim 3,
wherein the reproduction device comprises three or more loudspeaker drivers,
wherein the apparatus is configured to generate three or more audio channels for the three or more loudspeaker drivers of the reproduction device depending on the one or more audio object signals, depending on the first rendering information and depending on the second rendering information,
wherein the apparatus is configured to determine the second rendering information depending on a spatial arrangement of the three or more loudspeaker drivers within the reproduction device.

5. An apparatus according to claim 2,
wherein the apparatus is configured to determine the second rendering information depending on the position of each of the one or more audio objects depending on an orientation of the reproduction device in an environment.

6. An apparatus according to claim 2,
wherein the apparatus is configured to generate the two or more audio channels by generating two or more component channels, wherein the two or more audio channels are the two or more component channels or are derived from the two or more component channels,
wherein each of the two or more component channels is associated with one of the two or more components of the reproduction device, wherein each of the two or more components defines a different region around the reproduction device,
wherein the apparatus is configured to determine the second rendering information depending on a position of each audio object of the one or more audio objects, and depending on the two or more components, and
wherein the apparatus is configured to generate the two or more component channels using the second rendering information.

7. An apparatus according to claim 6,
wherein each component channel of the two or more component channels comprises signal portions of those of the one or more audio object signals of the one or more audio objects which are located in the region around the reproduction device, which is defined by the component that comprises said component channel.

8. An apparatus according to claim 6,
wherein each component channel of the two or more component channels comprises more average signal energy of the signal portions of those of the one or more audio object signals of the one or more audio objects which are located in the region around the reproduction device, which is defined by the component that comprises said component channel, than any other component channel of the two or more component channels,
wherein a first component channel of the two or more component channels comprises more average signal energy of the signal portions of an audio object signal of the one or more audio object signals than a second component channel, if an average of the signal energy of the signal portions of the audio object signal in the first component signal is greater than an average of the signal energy of the signal portions of the audio object signal in the second component signal.

9. An apparatus according to claim 6,
wherein each of the two or more components defines an angular region around the reproduction device such that each of the two or more components is definable by an angle.

10. An apparatus according to claim 6,
wherein the apparatus is configured to determine the second rendering information such that the second rendering information indicates a mapping rule for mapping the one or more audio object signals or one or more modified object signals derived from the one or more audio object signals to the two or more component channels depending on the two or more components associated with the two or more component channels and depending on the position of each audio object of the one or more audio objects which are associated with the one or more audio object signals.

11. An apparatus according to claim 6,
wherein the apparatus is configured to determine the two or more components differently depending on a property of an audio object signal of the one or more audio object signals, such that, if said audio object signal exhibits a first property, a region of at least one of the two or more components is different compared to if said audio object signal exhibits a different second property.

12. An apparatus according to claim 11,
wherein the first property of the audio object signal is that the audio object signal is a direct signal, and wherein the second property of the audio object signal is that the audio object signal is an ambience signal.

13. An apparatus according to claim 11,
wherein the first property of the audio object signal is that the audio object signal is a speech signal, and wherein the second property of the audio object signal is that the audio object signal is a non-speech signal.

14. An apparatus according to claim 6,
wherein the two or more audio channels are the two or more component channels.

15. An apparatus according to claim 6,
wherein the apparatus is configured to generate the two or more audio channels from the two or more component channels by processing at least one component channel of the two or more component channels, wherein the processing of the at least one component channel comprises one or more of:
amplifying or attenuating the at least one component channel in a time domain; and/or applying a gain and/or adding a delay to the at least one component channel in the time domain; and/or conducting a phase inversion on the at least one component channel in the time domain; and/or
applying a gain and/or adding a delay and/or conducting a phase inversion and/or a phase modification on one or more frequency bands of the at least one component channel in a frequency domain, and/or amplifying or attenuating at least one frequency band of the at least one component channel in a frequency domain; and/or
applying a filter operation on the at least one component channel; and/or
applying compression or limiting on the at least one component channel; and/or
applying equalisation on the at least one component channel.

16. An apparatus according to claim 1,
wherein the apparatus is configured to determine first rendering information depending on at least one distance being a distance between the position of the reproduction device and the position of an audio object of the one or more audio objects.

17. An apparatus according to claim 16,
wherein the at least one distance is an angular distance between the position of the reproduction device and the position of an audio object of the one or more audio objects.

18. An apparatus according to claim 16,
wherein the at least one distance is a linear distance between the position of the reproduction device and the position of an audio object of the one or more audio objects.

19. An apparatus according to claim 16,
wherein the apparatus is configured to determine the first rendering information such that the first rending information indicates that a first audio object of the one or more audio objects having a greater distance from the reproduction device than a second audio object of the one or more audio objects shall be attenuated more than the second audio object.

20. An apparatus according to claim 1,
wherein the apparatus is configured to determine the first rendering information depending on the position of each of the one or more audio objects and depending on at least one further reproduction device of one or more further reproduction devices,
wherein each further reproduction device of the one or more further reproduction devices is to reproduce one or more further audio signals for said further reproduction device, wherein said one or more further audio signals depend on the one or more audio object signals.

21. An apparatus according to claim 20,
wherein the apparatus is configured to determine the first rendering information depending on a capability to replay spatial sound of said at least one further reproduction device and/or depending on a position of said at least one further reproduction device.

22. An apparatus according to claim 21,
wherein the apparatus is configured to determine the first rendering information depending on the position of the reproduction device, depending on the position of each of the one or more audio objects and depending on a position of at least one of one or more further reproduction devices by employing amplitude panning.

23. An apparatus according to claim 21,
wherein the apparatus is configured to receive metadata comprising information on the position of each of the one or more further reproduction devices,
wherein the apparatus is configured to determine the first rendering information and/or the second rendering information using the information on the position of each of the one or more further reproduction devices.

24. An apparatus according to claim 23,
wherein the apparatus is configured to generate one or more modified object signals from the one or more audio object signals using the first rendering information which depends on the position of each of the one or more further reproduction devices, and
wherein the apparatus is configured to generate the one or more audio channels from the one or more modified object signals using the second rendering information.

25. An apparatus according to claim 21,
wherein the apparatus is configured to receive information on that another reproduction device being different from the one or more further reproduction devices is to start reproducing at least one further signal which depends on the one or more audio object signals, and wherein, in response to said information, the apparatus is configured to recalculate the first rendering information depending on said other reproduction device; and/or
wherein the apparatus is configured to receive information on that one of the one or more further reproduction devices is to stop or has stopped reproducing one or more audio signal being reproduced by the further reproduction device, and wherein, in response to said information the apparatus is configured to recalculate the first rendering information depending on said information.

26. An apparatus according to claim 1,
wherein the apparatus is configured to determine the first rendering information and/or the second rendering information depending on a listening position.

27. An apparatus according to claim 1,
wherein the apparatus is configured to generate the one or more audio channels for the reproduction device from two or more audio object signals, wherein each of the two or more audio object signals is associated with an audio object of two or more audio objects,
wherein the apparatus is configured to determine the first rendering information depending on a position of the reproduction device and depending on a position of each audio object of the two or more audio objects, and
wherein the apparatus is configured to generate the one or more audio channels from the two or more audio object signals depending on the first rendering information and depending on the second rendering information.

28. A reproduction device,
wherein the reproduction device comprises the apparatus according to claim 1,
wherein the apparatus according to claim 1 is configured to generate one or more audio channels for the reproduction device.

29. A system, comprising:
the reproduction device of claim 28, being a first reproduction device, and
one or more further reproduction devices.

30. A system according to claim 29,
wherein the apparatus according to claim 1 of the first reproduction device is configured to determine the first rendering information depending on the position of the first reproduction device, depending on the position of each of the one or more audio objects and depending on a position of at least one of the one or more further reproduction devices.

31. A system according to claim 29,
wherein the apparatus according to claim 1 of the first reproduction device, is configured to generate the one or more audio channels for the first reproduction device,
wherein, for each further reproduction device of the one or more further reproduction devices, the apparatus according to claim 1 of the first reproduction device is configured to generate one or more audio channels for said further reproduction device, wherein, for generating the one or more audio channels for said further reproduction device, the apparatus according to claim 1 of the first reproduction device is configured
to determine first further rendering information for said further reproduction device depending on a position of the further reproduction device and depending on a position of each audio object of the one or more audio objects,
to determine second further rendering information for said further reproduction device depending on a capability of the further reproduction device to replay spatial sound, and
to generate the one or more audio channels for said further reproduction device from the one or more audio object signals depending on the first further rendering information for said further reproduction device and depending on the second further rendering information for said further reproduction device.

32. A system according to claim 29,
wherein each of the one or more further reproduction devices comprises an apparatus according to claim 1,
wherein, the apparatus according to claim 1 of each further reproduction device of the one or more further reproduction devices is configured to generate one or more audio channels for said further reproduction device, wherein, for generating the one or more audio channels for said further reproduction device, the apparatus according to claim 1 of said further reproduction device is configured
to determine first further rendering information for said further reproduction device depending on a position of the further reproduction device and depending on a position of each audio object of the one or more audio objects,
to determine second further rendering information for said further reproduction device depending on a capability of the further reproduction device to replay spatial sound, and
to generate the one or more further audio channels for said further reproduction device from the one or more audio object signals depending on the first further rendering information for said further reproduction device and depending on the second further rendering information for said further reproduction device.

33. A method for generating one or more audio channels for a reproduction device from one or more audio object signals, wherein each of the one or more audio object signals is associated with an audio object of one or more audio objects, wherein the method comprises:
determining first rendering information depending on a position of the reproduction device and depending on a position of each audio object of the one or more audio objects,
determining second rendering information depending on a capability of the reproduction device to replay spatial sound, and
generating the one or more audio channels from the one or more audio object signals depending on the first rendering information and depending on the second rendering information.

34. A non-transitory digital storage medium having a computer program stored thereon to perform the method for generating one or more audio channels for a reproduction device from one or more audio object signals, wherein each of the one or more audio object signals is associated with an audio object of one or more audio objects, wherein the method comprises:
determining first rendering information depending on a position of the reproduction device and depending on a position of each audio object of the one or more audio objects,
determining second rendering information depending on a capability of the reproduction device to replay spatial sound, and
generating the one or more audio channels from the one or more audio object signals depending on the first rendering information and depending on the second rendering information,
when said computer program is run by a computer.
